(19) United States
(12) Patent Application Publication
(10) Pub. No.: US 2015/0306748 A1
(43) Pub. Date: Oct. 29, 2015

(54) ENERGY-EFFICIENT ELECTRIC SCREW DRIVERS

(71) Applicant: Hsiu-Lin Hsu, New Tapei City (TW)

(72) Inventor: Hsiu-Lin Hsu, New Tapei City (TW)

(21) Appl. No.: 14/259,441

(22) Filed: Apr. 23, 2014

(51) Int. Cl. B25B 21/00

(52) U.S. Cl. CPC B25B 21/007

(57) ABSTRACT

An energy-efficient electric screw driver designed to have three adjustment modes, including: Sport, Normal and ECO. The capacitor is mounted in the control panel of the electric screw driver and is combined with the battery for use. MCU can limit and change current at different torsions and startup current when the rotating speed is constant. The battery current output can be controlled. At different modes, the power saving effect can be achieved. Lower current also reduces battery temperature, saves power and prolongs battery life.

### BACKGROUND OF INVENTION

1. Field of the Invention

The present invention relates generally to an electric screw driver, and more particularly to an energy-efficient electric screw driver which is environment friendly, and can save energy and costs.

2. Description of Related Art

The power supply of general electric screw drivers has been changed from power outlets to rechargeable battery. They are not limited by power sources; however, rechargeable battery has time limitation. Thus, electric screw drivers cannot be used if the power is lower.

Generally, maximum horsepower is used regardless of torsion when the electric screw drivers lock the screws, and users seldom adjust the torsion to the maximum. Normally, the maximum value ranges from 30% to 80%. Especially, horsepower at the maximum torsion during operation may cause high temperature of screw driver, energy consumption and reduce service life.

The electric screw drivers are a small automatic tool operated by hand. However, due to limited storage of battery, the battery power may use up unconsciously in use.

### SUMMARY OF THE INVENTION

The primary objective of the present invention is to provide an energy-efficient electric screw driver, which battery run time is prolonged, and it can increase use efficiency. Furthermore, different functions of the electric screw driver can be selected at different torsions through switching operation of various energy-saving modes.

The second objective of the present invention is to provide an energy-efficient electric screw driver, which can increase service life of the battery, and has substantial effect on CO2 emission reduction and energy saving.

In order to achieve these purposes, the inventor designs a novel energy-efficient electric screw driver, and mainly increases three adjustment modes, including: Sport, Normal and ECO; the internal control panel of the electric screw drivers has capacitor coupled with batteries. The MCU in the internal control panel is used to limit current different torsions and output start-up current at different modes when rotating speed is constant, and the battery current output can be controlled. At different energy-saving modes, the power can be saved, and meanwhile, power saving also reduces battery temperature. Power saving can prolong the service life of the battery.

Said ECO means soft start-up mode when the range of the torsion output and battery electric output is 30%˜50%.

Said Normal means normal start-up mode when the range of torsion output and battery electric output is 50%˜80%.

Said Sport means rapid startup mode when the range of torsion output and battery electric output is 80%˜100%.

When said ECO or Normal of electric screw drivers is started up and load is greater than output horsepower, the screws cannot be locked. The MCU can automatically switch ECO or Normal to Sport to lock the screws.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 illustrates external view of the electric screw driver.

FIG. 2 illustrates bottom view of the electric screw driver.

FIG. 3 illustrates circuit diagram of control device.

FIG. 4 illustrates ECO flow chart.

FIG. 5 illustrates Normal flow chart.

FIG. 6 illustrates Sport flow chart.

FIG. 7 illustrates flow chart of the control device.

FIG. 8(A) illustrates the comparison of the actual motor current of the invented driver with the general electric screw driver when charge-discharge of the batteries exceeds 500 times.

FIG. 8(B) illustrates the comparison of the actual motor current of the invented driver with the general electric drive when new batteries are used.

FIG. 8(C) illustrates the comparison of the screw locking times at different modes when the batteries have the same capacity and are full.

FIG. 8(D) illustrates the comparison of temperature change of the invented electric screw driver with general electric screw driver at the normal service time.

### DETAILED DESCRIPTION OF THE INVENTION

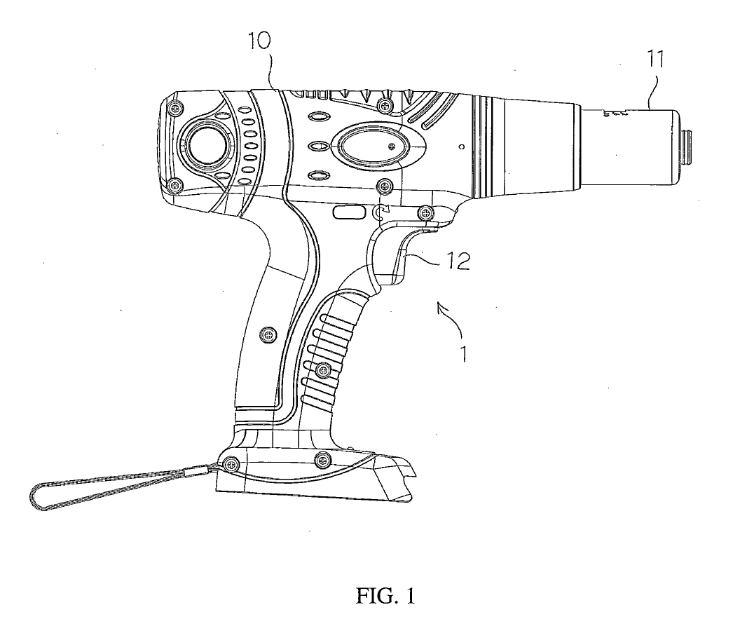

Refer to FIG. 1, it discloses power-saving mode electric screw driver. The electric screw driver (1) is rechargeable, equipped with one set of matched housing (10). The housing (10) is not intended to limit the invention, such as pen type and gun type. In the present invention, inside of the housing (10) comprises: Motor device (not shown in the figure), gear unit (not shown in the figure), clutch (not shown in the figure), grip (11), trigger (12) and control device (not shown in the figure); these devices are basic structure and functions of the general (brushless) electric screw drivers. The focus of the patent application is not described repeatedly:

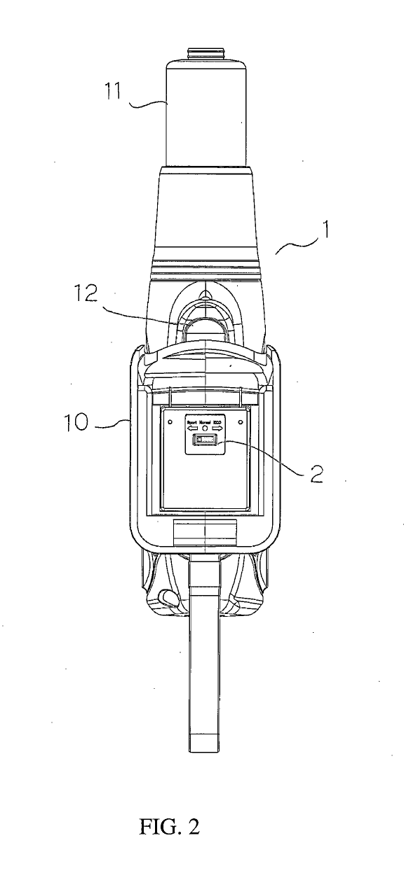

As shown in FIG. 2, main feature of the present invention is to mount one capacitor in the control device of electric screw driver (1), and it is combined with the rechargeable battery to provide power for startup of the screw driver (1). In the subject embodiment, the control device structure comprises: ECO switch (2), Capacitor) (3), MOSFET) (4) and MCU (5); output of the control device is electrically connected with the rechargeable battery (6), and the output is electrically connected with motor (7).

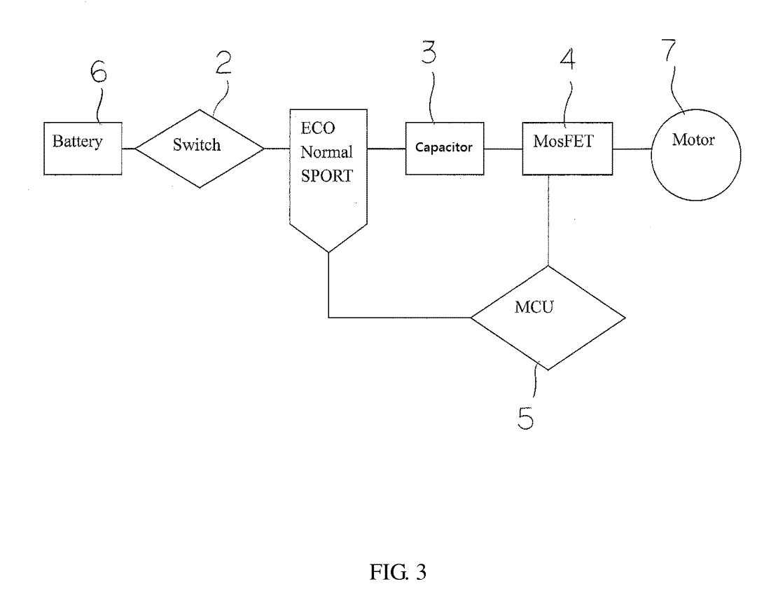

Refer to FIG. 3, the action principle of the control device is: The startup current is output from battery (6), and the switch (2) has different power saving modes. MCU (5) can make different curette output (50%, 80% and 100%), and other current is supplied by Capacitor) (3). MCU controls MOSFET) (4) to drive and start up the motor (7). Thus, in the present invention, the control device is mainly used to control normal startup, use and current of the electric screw drivers, and the rotating speed is not changed. The efficiency and quality of screw locking is not affected.

The operation of the electric screw drivers at different modes and the functions are described as follows: ECO means the torsion output range is 30%˜50% and motor is at soft startup mode; Normal means the torsion output range is 50%˜80%, and the motor is at normal startup mode; Sport means the torsion output range is 80%˜100%, and the motor is at fast startup mode.

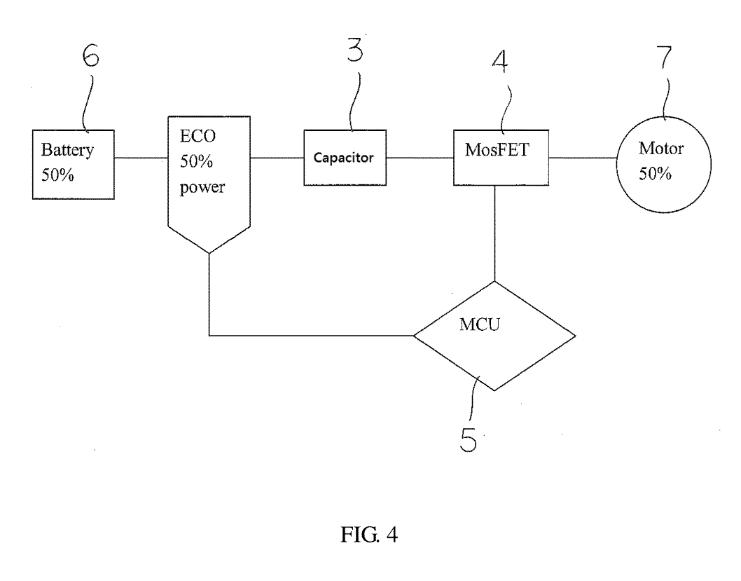

Please refer the ECO flow charts to FIG. 4. As shown in the figure, after the current supplied by the battery (6) flows through the switch, part of current is stored in the capacitor. MCU (5) is used to control MOSFET (4) to drive the motor (7). Because startup of the motor needs higher current, the high current is supplied by the capacitor (3), and the motor (7) can run upon soft startup. Thus, not all high startup current is supplied by the battery. After the motor (7) runs, the battery (6) supplies continuous power. For efficiency, when the switch is adjusted to ECO, the maximum horsepower of the motor (7) is preset to 50%, and battery supplies 50% of power. At this load, the maximum output horsepower is 50%.

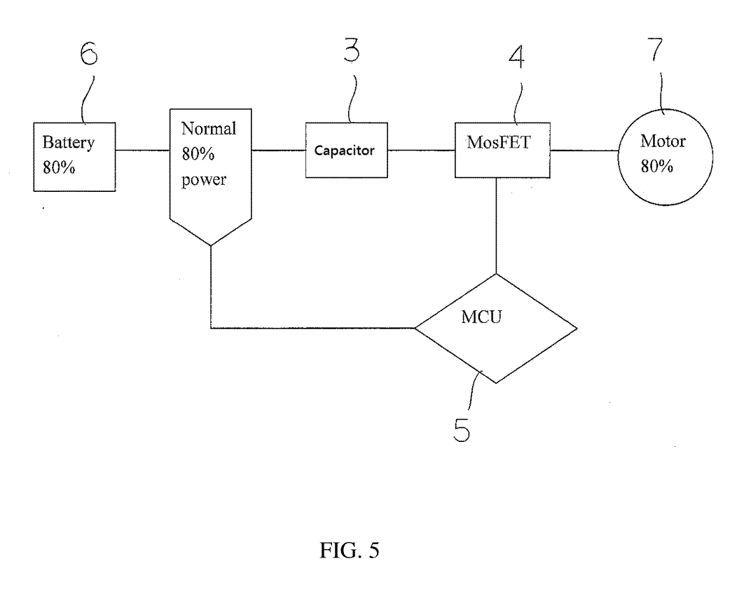

Refer Normal flow chart to FIG. 5; as shown in the figure, when the switch (2) is adjusted to the Normal and the maximum horsepower of the motor (7) is preset to 80%, the battery (6) only supplies 80% of power to drive the motor at Normal. In the subject embodiment, the maximum output horsepower of the motor (7) is 80%.

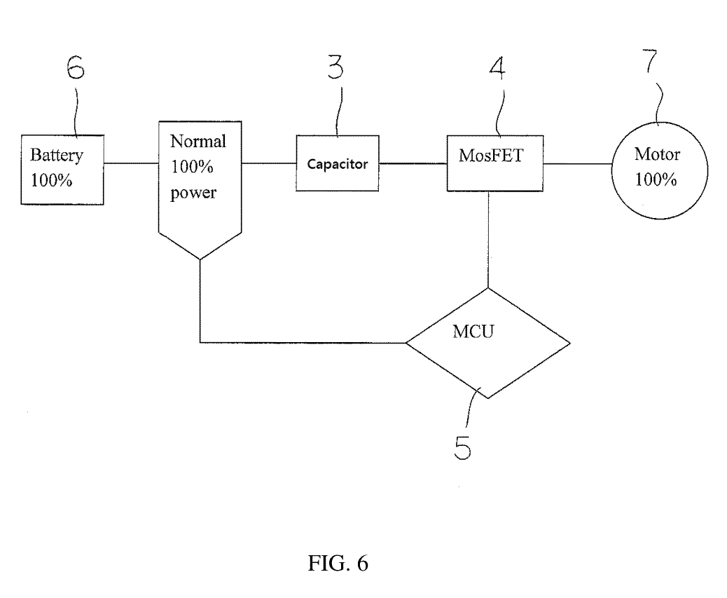

Refer to Sport flow chart for FIG. 6; as shown in the figure, when the switch (2) is adjusted to Sport, and the maximum horsepower of the motor (7) is 100% and the battery (6) will supply 100% of power, and drives fast startup of the motor (7). In the subject embodiment, the maximum output horsepower of the motor (7) is 100%.

If load of the electric screw driver at ECO or Normal is greater than the preset maximum output horsepower (50% or 80%), some screw locking may fail. At this time, the MCU (5) may automatically adjust the switch (2) from ECO or Normal to Sport, and the electric screw driver can lock the screws at the minimum power consumption.

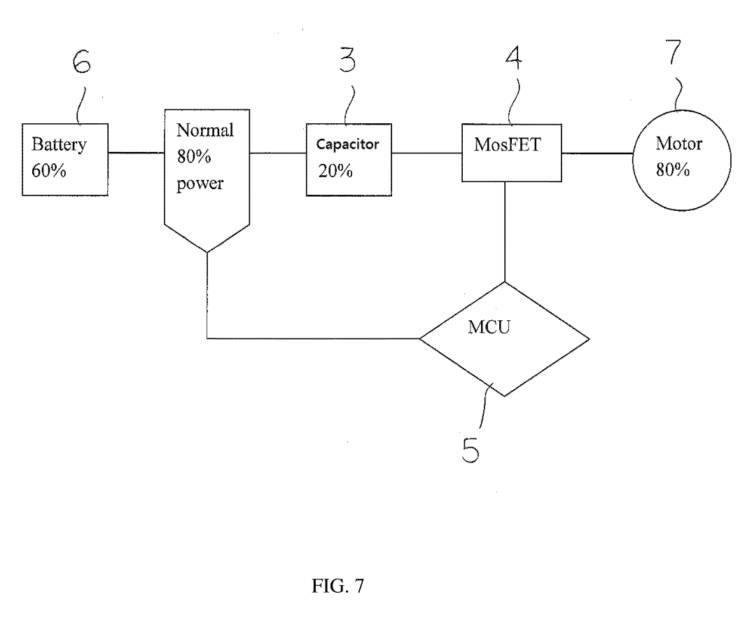

Refer flow chart of the electric screw driver after use to FIG. 7. As shown in the figure, ageing may occur if the battery (6) is repeatedly charged, and the power is only 60%. If power of the electric screw driver (1) needs to reach 80%, the capacitor (3) can supply the rest of power to drive the motor (7) and ensure normal work; this can increase battery life, reduce loss of battery power, and reduce energy consumption and CO2 emission.

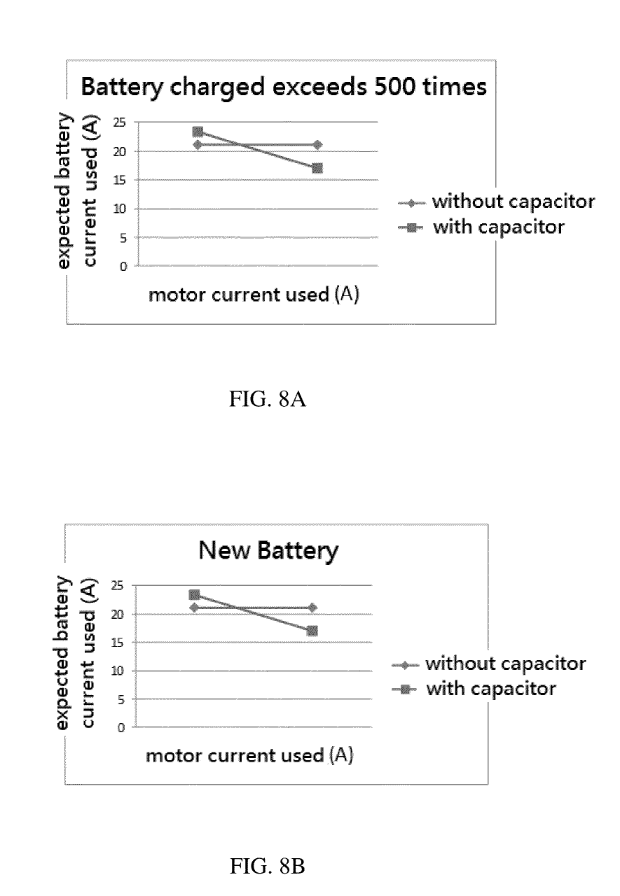

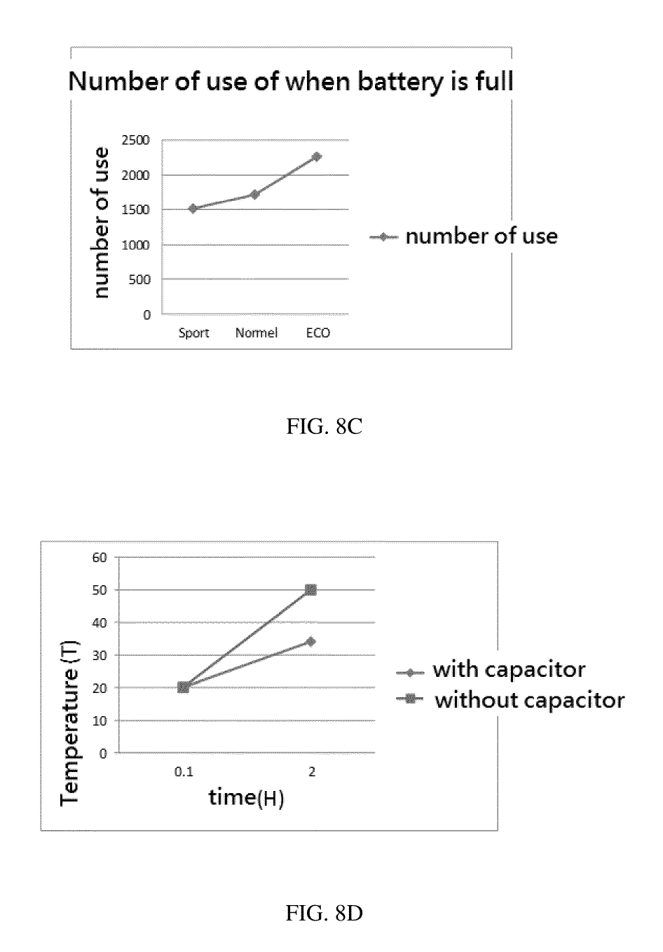

Refer the measurement of the battery of invented electric screw driver with that of the general electric screw driver to FIG. 8(A)-(D); FIG. 8(A) and (B) illustrate comparison of the motor current of invented electric screw driver with the general electric screw driver when charging of the batteries exceeds 500 times or the batteries are new. As shown in the figures, it can be seen that the current supplied by the battery is lower for the invented electric screw driver equipped with the capacitor regardless of using new or old batteries. Based on the actually measured values, 25-35% of power can be saved, and power saving effect is achieved.

FIG. 8(C) illustrates times of the screw locking of the invented electric screw drivers at different modes when the battery storage is the same and full. The figure shows the horsepower and maximum current can obtain maximum torsion output at Sport. After measurement, the screw locking of the invented electric screw drivers reaches 1500 times; at Normal the battery current output is controlled. After measurement, the motor has maximum horsepower, the maximum torque output is 80%, and the locking times are increased by 50%. After measurement, the screw locking can reach 1700 times; at ECO, startup, use and shutdown current and maximum current (maximum current reaches 50%) can be controlled, and the rotating speed is not changed. The threshold current action is made to control current output, and the power can be saved (70% of power can be saved). Further, two times screw locking can be reduced. After measurement, the locking can reach 2300. Thus, effect on the electric screw drivers can be significantly improved.

FIG. 8(D) illustrates comparison of the temperature change of the invented electric screw drivers with the general electric screw drivers at the normal service time. As shown in the figure, the capacitor mounted in the invented electric screw drivers can be used for 2 hours. The temperature rise is half of the general electric screw driver. In the long time operation, the battery temperature rise is smaller. Thus, the battery life can be prolonged.

1. An energy-efficient electric screw driver; the control device structure of the electric screw driver comprises: the energy-efficient switch, capacitor, MOSFET and MCU can be connected electrically; the control device output is electrically connected with the battery and the output is electrically connected with the motor.

2. The energy-efficient electric screw driver as claimed in claim 1, wherein energy-saving modes include Sport, Normal and ECO.

3. The device defined in claim 2, wherein ECO means range of the torsion output and battery output is 30%˜50% and soft startup current output.

4. The energy-efficient electric screw driver as claimed in claim 2, wherein Normal means range of the torsion output and battery output is 50%˜80% and general startup current output.

5. The an energy-efficient electric screw driver as claimed in claim 2, wherein Sport means range of the torsion output and battery output is 80%˜10% and rapid startup current output.

6. The energy-efficient electric screw driver as claimed in claim 2, wherein load of the electric screw drivers at ECO or Normal is greater than the output horsepower, and the screw locking cannot be finished; MCU can automatically adjust the switch from ECO to Sport to finish screw locking.
